(19) United States
(12) Patent Application Publication
(10) Pub. No.: US 2026/0352611 A1
(43) Pub. Date: Nov. 5, 2026

(54) SYSTEM AND METHOD FOR DISTRIBUTED COMMUNICATION TRAFFIC ENGINEERING AND MULTI-TENANT RESOURCE ALLOCATION IN HYBRID NETWORKS

(71) Applicant: SAI RAGHU RAM GUMMADIDALA, Ashburn, VA (US)

(72) Inventor: SAI RAGHU RAM GUMMADIDALA, Ashburn, VA (US)

(21) Appl. No.: 19/719,900

(22) Filed: Jun. 25, 2026

(51) Int. Cl. H04L 47/78

(52) U.S. Cl. CPC H04L 47/781

(57) ABSTRACT

A method for method for traffic engineering and multi-tenant resource allocation in a hybrid network environment is disclosed. The method includes receiving, by a distributed network orchestration engine, network communication data associated with one or more communication flows exchanged among a plurality of computing resources operating in the hybrid network environment. The method includes generating, by the distributed network orchestration engine, a network relationship model representing communication characteristics associated with the plurality of computing resources. The method includes determining, from the network relationship model, one or more traffic conditions and one or more resource utilization conditions. The method includes generating one or more traffic engineering policies based on the one or more traffic conditions and the one or more resource utilization conditions. The method includes allocating one or more network resources to at least one tenant according to the one or more traffic engineering policies.

### COPYRIGHT AND TRADEMARK NOTICE

This application includes material which is subject or may be subject to copyright and/or trademark protection. The copyright and trademark owner(s) have no objection to the facsimile reproduction by any of the patent disclosure, as it appears in the Patent and Trademark Office files or records, but otherwise reserves all copyright and trademark rights whatsoever.

### TECHNICAL FIELD

The present disclosure generally relates to network traffic engineering and resource orchestration systems. More particularly relates to systems and methods for traffic-aware and tenant-aware resource allocation in hybrid network environments comprising distributed computing infrastructures, cloud platforms, virtualized environments, and edge computing domains.

### BACKGROUND OF THE INVENTION

Enterprise computing environments increasingly operate across hybrid infrastructures that integrate on-premise systems, cloud computing platforms, edge environments, software-defined networks, and virtualized data center resources. Such distributed environments support large numbers of tenant workloads, containerized applications, microservices, virtual machines, and dynamically scalable computing resources that continuously exchange communication flows across multiple network domains. As communication dependencies among distributed workloads increase, internal network traffic within hybrid infrastructures becomes highly dynamic, unpredictable, and resource-intensive.

Conventional traffic management approaches primarily focus on static routing mechanisms, isolated bandwidth allocation schemes, or localized congestion handling techniques that are unable to efficiently coordinate communication flows across distributed hybrid infrastructures. Existing systems often lack tenant-aware orchestration capabilities and fail to account for workload mobility, communication affinity relationships, dynamic scaling events, resource contention conditions, and multi-domain communication dependencies. As a result, communication bottlenecks, inefficient resource utilization, congestion propagation, service latency degradation, and cross-tenant performance interference frequently occur in hybrid computing environments.

In many existing network environments, traffic engineering operations and infrastructure resource allocation mechanisms are managed independently from one another. Such disjointed management architectures are unable to dynamically correlate communication-flow behavior with real-time infrastructure utilization conditions, thereby limiting the ability of the network to adapt to workload migrations, burst communication conditions, tenant scaling events, and failover scenarios. Furthermore, conventional systems are generally incapable of continuously regenerating traffic engineering policies responsive to changing operational states without interrupting active communication sessions.

Additionally, conventional hybrid network management systems typically lack mechanisms for generating unified network relationship models capable of correlating communication dependencies, tenant isolation constraints, workload affinity relationships, congestion states, and resource consumption conditions across distributed infrastructures. Existing approaches further fail to provide adaptive traffic engineering policies that simultaneously optimize communication-path allocation, bandwidth reservation, virtual network orchestration, and tenant-aware resource distribution in real time.

Accordingly, there exists a need for an improved traffic engineering and resource orchestration framework capable of dynamically analyzing distributed communication flows, determining resource utilization conditions, generating adaptive tenant-specific traffic engineering policies, and autonomously reallocating network and infrastructure resources across hybrid computing environments while maintaining communication continuity, tenant isolation, and optimized infrastructure utilization.

### SUMMARY OF THE INVENTION

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a method for traffic engineering and multi-tenant resource allocation in a hybrid network environment is disclosed. The method includes receiving, by a distributed network orchestration engine, network communication data associated with one or more communication flows exchanged among a plurality of computing resources operating in the hybrid network environment. The method includes generating, by the distributed network orchestration engine, a network relationship model representing communication characteristics associated with the plurality of computing resources. The method includes determining, from the network relationship model, one or more traffic conditions and one or more resource utilization conditions associated with the plurality of computing resources. The method includes generating one or more traffic engineering policies based on the one or more traffic conditions and the one or more resource utilization conditions. The method includes allocating one or more network resources to at least one tenant according to the one or more traffic engineering policies.

In accordance with another embodiment of the present disclosure, a system for traffic engineering and multi-tenant resource allocation in a hybrid network environment is disclosed. The system includes a memory, at least one processor is operatively coupled with the memory. The at least one processor is configured to receive, using a distributed network orchestration engine, network communication data associated with one or more communication flows exchanged among a plurality of computing resources operating in the hybrid network environment. The at least one processor is configured to generate, using the distributed network orchestration engine, a network relationship model representing communication characteristics associated with the plurality of computing resources. The at least one processor is configured to determine, from the network relationship model, one or more traffic conditions and one or more resource utilization conditions associated with the plurality of computing resources. The at least one processor is configured to generate one or more traffic engineering policies based on the one or more traffic conditions and the one or more resource utilization conditions. The at least one processor is configured to allocate one or more network resources to at least one tenant according to the one or more traffic engineering policies.

In accordance with another embodiment of the present disclosure, a non-transitory computer-readable medium storing instructions that, when executed, cause a processor to receive network communication data associated with one or more communication flows exchanged among a plurality of computing resources operating in the hybrid network environment. The processor to generate a network relationship model representing communication characteristics associated with the plurality of computing resources. The processor to determine one or more traffic conditions and one or more resource utilization conditions associated with the plurality of computing resources. The processor to generate one or more traffic engineering policies based on the one or more traffic conditions and the one or more resource utilization conditions. The processor to allocate one or more network resources to at least one tenant according to the one or more traffic engineering policies.

One or more advantages of the prior art are overcome, and additional advantages are provided through the invention. Additional features are realized through the technique of the invention. Other embodiments and aspects of the disclosure are described in detail herein and are considered a part of the invention.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates an exemplary environment for establishing a system of traffic engineering and multi-tenant resource allocation in a hybrid network environment, in accordance with an embodiment of the present disclosure;

FIG. 2A illustrates the system for traffic engineering and multi-tenant resource allocation, in accordance with an embodiment of the present disclosure;

FIG. 2B illustrates modules associated with the system, in accordance with an embodiment of the present disclosure; and

FIG. 3 illustrates a flowchart depicting a method for traffic engineering and multi-tenant resource allocation in the hybrid network environment, in accordance with an embodiment of the present disclosure.

Skilled artisans will appreciate the elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed. It shall be understood that different aspects of the invention can be appreciated individually, collectively, or in combination with each other.

The present disclosure provides a system and method for traffic engineering and multi-tenant resource allocation in a hybrid network environment. The disclosed system enables intelligent coordination of distributed communication flows and dynamic allocation of infrastructure resources across heterogeneous computing domains including cloud infrastructures, virtualized environments, edge infrastructures, software-defined network environments, and on-premise computing systems. The disclosed architecture continuously analyzes communication-flow behavior, determines infrastructure utilization conditions, and dynamically generates adaptive traffic engineering policies to optimize communication performance, tenant isolation, and resource distribution across the hybrid network environment.

The disclosed system improves operational efficiency by correlating communication dependencies, workload distribution characteristics, congestion states, and resource utilization conditions associated with distributed computing resources. The disclosed framework further enables autonomous traffic engineering policy generation and dynamic resource reallocation responsive to changing network conditions, workload migration events, tenant scaling operations, and infrastructure failover conditions.

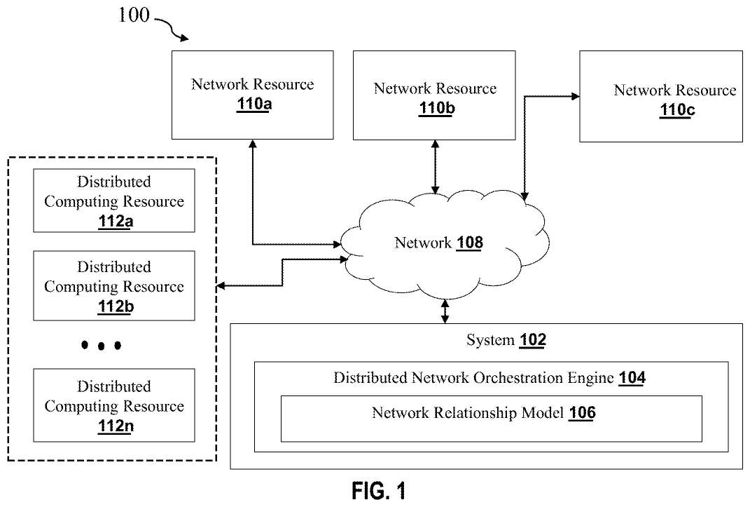

An environment and various implementations for environment and processes may be described with reference to FIG. 1 showing an architectural level schematic of a system in accordance with an implementation. Because FIG. 1 is an architectural diagram, certain details are intentionally omitted to improve the clarity of the description. The discussion of FIG. 1 will be organized as follows. First, the elements of the figure will be described, followed by their interconnections. Then, the use of the elements in the environment will be described in greater detail.

Referring now to the drawings, and more particularly to FIG. 1 through FIG. 3, where similar reference characters denote corresponding features consistently throughout the figures, there are shown preferred embodiments and these embodiments are described in the context of the following exemplary system and/or method.

FIG. 1 illustrates an exemplary environment for establishing a system 102 for traffic engineering and multi-tenant resource allocation in a hybrid network environment, in accordance with an embodiment of the present disclosure. The environment 100 includes a system 102, a distributed network orchestration engine 104, a network relationship model 106, a network 108, and one or more network resources 110a, 110b, and 110c.

The system 102 may include a centralized or distributed computing platform configured to coordinate traffic engineering operations and tenant-aware infrastructure resource allocation across the hybrid network environment. In one embodiment, the system 102 may operate as a distributed orchestration platform deployed across multiple cloud regions, edge infrastructures, virtualized infrastructures, and software-defined networking domains.

The system 102 may continuously monitor communication-flow behavior associated with distributed workloads executing throughout the hybrid network environment. Such communication flows may include service-to-service communication flows, inter-container communication flows, workload synchronization communication flows, distributed storage communication flows, virtual machine communication flows, application programming interface (API) communication flows, telemetry communication flows, or tenant-associated communication exchanges.

For example, within a distributed enterprise cloud environment, workloads associated with financial transaction processing, fraud analytics, identity verification, customer management, and data synchronization services may exchange large volumes of communication traffic across geographically separated infrastructures. The system 102 may continuously analyze communication intensity, workload dependencies, routing conditions, and infrastructure utilization levels associated with such communication exchanges.

In another embodiment, the system 102 may operate within an edge computing environment supporting autonomous industrial systems. Edge devices deployed across manufacturing facilities may continuously exchange telemetry information, sensor-processing data, and machine-learning inference results with centralized cloud infrastructures. The system 102 may intelligently redistribute communication flows and dynamically allocate infrastructure resources to maintain low-latency industrial control operations despite changing communication conditions.

The distributed network orchestration engine 104 may include one or more orchestration components configured to receive communication-flow information and generate adaptive traffic engineering policies responsive to operational conditions associated with the hybrid network environment.

In one embodiment, the distributed network orchestration engine 104 may dynamically coordinate communication-flow routing operations across multiple infrastructure domains including cloud infrastructures, edge infrastructures, software-defined networking infrastructures, virtual overlay networks, and distributed data center environments. The distributed network orchestration engine 104 may continuously determine congestion conditions, communication dependencies, workload affinity relationships, infrastructure utilization conditions, tenant-specific communication requirements, and workload migration events associated with distributed workloads.

The distributed network orchestration engine 104 may further dynamically regenerate traffic engineering policies responsive to network-state variations without interruption of active communication sessions. Such dynamic orchestration capabilities improve operational continuity and infrastructure resilience within highly distributed hybrid environments.

For example, during a large-scale live-streaming event, viewer demand may rapidly increase within multiple geographic regions. The distributed network orchestration engine 104 may proactively identify increasing communication density between edge streaming servers and distributed storage infrastructures. Responsive to such operational conditions, the distributed network orchestration engine 104 may dynamically redirect communication flows through alternative communication paths, reserve additional bandwidth resources, and allocate supplementary compute resources within affected edge locations.

The network relationship model 106 may include a dynamically generated representation of communication relationships associated with a plurality of distributed computing resources 112a, 112b . . . 112n operating within the hybrid network environment. The network relationship model may include, but is not limited to, a tenant-context graph, and the like. The plurality of distributed computing resources 112a, 112b . . . 112n may include a plurality of tenant workloads distributed across on-premise infrastructure, virtualized infrastructure, cloud infrastructure, edge infrastructure, or combinations thereof.

In one embodiment, the network relationship model 106 may include a graph-based relationship structure representing workload affinity relationships, communication dependencies, service interaction patterns, communication-flow intensity conditions, congestion propagation characteristics, infrastructure utilization states, and tenant isolation constraints associated with distributed workloads.

The network relationship model 106 may continuously evolve responsive to operational variations occurring throughout the hybrid network environment. For example, workload migration operations, infrastructure scaling events, failover transitions, communication surges, tenant onboarding events, and virtual network reconfiguration operations may dynamically modify communication dependencies among distributed resources. The network relationship model 106 may continuously update such operational relationships to maintain accurate infrastructure visibility.

In one embodiment, the network relationship model 106 may identify communication clusters associated with highly interactive workloads. The disclosed framework may utilize such communication cluster information to optimize communication-path allocation and reduce cross-domain communication latency.

For example, within a distributed healthcare infrastructure, diagnostic imaging services, patient-record databases, machine-learning inference systems, and edge-based clinical devices may exchange large communication volumes during emergency diagnostic procedures. The network relationship model 106 may dynamically identify high-priority communication dependencies associated with emergency medical operations and may prioritize communication resources accordingly.

The network 108 may include one or more public communication networks, private communication networks, cloud interconnect infrastructures, software-defined networking infrastructures, virtual overlay networks, wireless communication networks, edge communication infrastructures, or combinations thereof.

The network 108 may facilitate communication among distributed workloads, cloud infrastructures, orchestration systems, storage infrastructures, tenant environments, and edge devices operating within the hybrid network environment.

In one embodiment, the network 108 may include dynamically configurable software-defined communication paths capable of selectively redirecting communication flows responsive to generated traffic engineering policies. The disclosed framework may thereby continuously optimize communication routing operations across heterogeneous infrastructures.

The one or more network resources 110a, 110b, and 110c may include physical computing infrastructures, virtualized resources, communication bandwidth resources, software-defined networking resources, virtual network interfaces, accelerator resources, storage infrastructures, cloud computing resources, or distributed edge resources associated with the hybrid network environment.

The distributed network orchestration engine 104 may continuously allocate, reserve, redistribute, prioritize, or reassign the one or more network resources 110a, 110b, and 110c according to generated traffic engineering policies and determined operational conditions.

For example, during a workload migration event involving distributed artificial intelligence inference workloads, the disclosed framework may dynamically allocate additional accelerator resources and communication bandwidth to migrating inference workloads while simultaneously redirecting lower-priority analytics communication flows through alternative communication paths.

In another embodiment, the disclosed framework may autonomously detect congestion propagation conditions associated with overloaded cloud infrastructures. Responsive to such congestion conditions, the distributed network orchestration engine 104 may reserve replacement compute resources within alternative infrastructures and selectively redistribute communication flows to prevent service degradation.

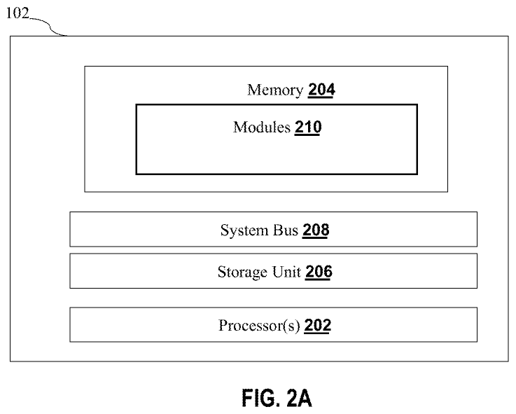

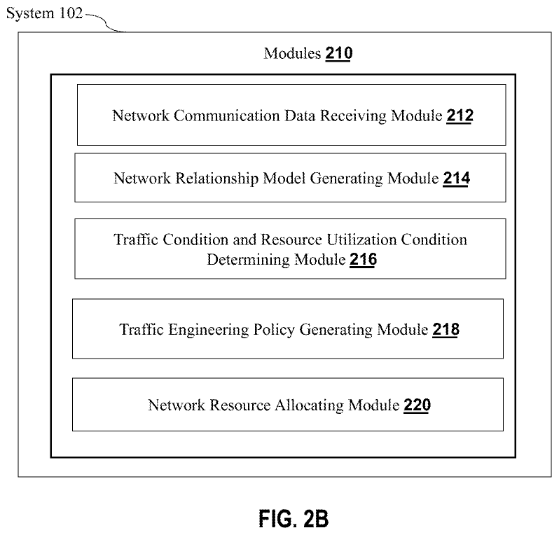

FIG. 2A illustrates the system 102, in accordance with an embodiment of the present disclosure. The system 102 may include a processor 202, a memory 204, a storage unit 206, a system bus 208, and modules 210.

The processor 202 may include one or more microprocessors, distributed processing units, application-specific integrated circuits, programmable logic devices, hardware accelerators, or multi-core processing architectures configured to execute instructions associated with traffic engineering operations and tenant-aware resource orchestration procedures.

In one embodiment, the processor 202 may execute predictive communication analysis operations, congestion mitigation procedures, infrastructure orchestration algorithms, machine-learning operations, communication-flow optimization procedures, and policy-generation operations associated with the disclosed framework.

The memory 204 may include volatile memory, non-volatile memory, cache memory, distributed memory resources, or temporary storage infrastructures configured to store executable instructions, communication telemetry information, workload dependency information, tenant operational data, infrastructure utilization information, policy configurations, and intermediate operational results associated with the disclosed system.

The storage unit 206 may include persistent storage infrastructures configured to store historical communication-flow information, infrastructure telemetry histories, traffic engineering rules, network topology information, machine-learning models, operational policies, congestion histories, tenant-specific operational profiles, and workload relationship information.

In one embodiment, the storage unit 206 may maintain historical communication patterns associated with distributed workloads. Such historical operational information may be utilized by predictive analysis models to forecast future communication surges, workload scaling conditions, and congestion propagation risks.

The system bus 208 may include one or more communication interfaces configured to facilitate data exchange among the processor 202, the memory 204, the storage unit 206, and the modules 210.

The system bus 208 may further support communication with distributed cloud infrastructures, edge infrastructures, software-defined networking controllers, virtualized infrastructures, and external orchestration platforms associated with the hybrid network environment.

The modules 210 may include hardware modules, software modules, firmware modules, distributed orchestration components, virtualized orchestration services, containerized orchestration agents, or combinations thereof configured to perform communication-flow analysis, infrastructure orchestration, adaptive policy generation, resource allocation operations, and congestion mitigation procedures.

FIG. 2B illustrates the modules 210 associated with the system 102, in accordance with an embodiment of the present disclosure. The modules 210 may include a network communication data receiving module 212, a network relationship model generating module 214, a traffic condition and resource utilization condition determining module 216, a traffic engineering policy generating module 218, and a network resource allocating module 220.

The network communication data receiving module 212 may be configured to receive network communication data associated with communication flows exchanged among the plurality of distributed computing resources 112a, 112b . . . 112n operating within the hybrid network environment.

The received network communication data may include telemetry information, packet metadata, workload identifiers, communication session information, routing information, virtual network interface statistics, bandwidth utilization information, infrastructure monitoring information, queue occupancy information, communication retry information, tenant identifiers, congestion indicators, or communication-flow state information.

In one embodiment, the network communication data receiving module 212 may continuously aggregate telemetry information from distributed routers, cloud infrastructures, virtual switches, edge gateways, software-defined networking controllers, container orchestration platforms, and distributed monitoring systems.

For example, within a distributed autonomous transportation infrastructure, the network communication data receiving module 212 may receive communication telemetry associated with edge-based navigation systems, cloud-based route optimization infrastructures, vehicle coordination systems, and distributed sensor-processing platforms.

The network relationship model generating module 214 may be configured to generate the network relationship model 106 based on the received network communication data. In one embodiment, the network relationship model generating module 214 may correlate communication dependencies, service affinity relationships, tenant isolation constraints, workload interaction patterns, communication intensity levels, infrastructure utilization states, routing-path dependencies, and congestion propagation characteristics associated with distributed workloads.

The network relationship model generating module 214 may continuously update the network relationship model 106 responsive to workload migrations, communication surges, infrastructure failures, tenant onboarding operations, virtual network reconfiguration events, or failover transitions.

For example, during deployment of distributed cloud-native applications, containers associated with authentication services, database services, caching infrastructures, and analytics platforms may continuously scale according to user demand. The network relationship model generating module 214 may dynamically identify changing communication dependencies among such services and may continuously update communication relationship structures accordingly.

The traffic condition and resource utilization condition determining module 216 may be configured to determine traffic conditions and resource utilization conditions associated with the plurality of distributed computing resources 112a, 112b . . . 112n. The traffic conditions may include communication latency conditions, congestion propagation conditions, communication-flow burst conditions, queue occupancy conditions, bandwidth utilization conditions, routing instability conditions, communication retry conditions, packet processing conditions, or communication jitter conditions.

The resource utilization conditions may include processor utilization levels, memory utilization conditions, storage access conditions, virtual network interface utilization conditions, accelerator resource utilization conditions, tenant-specific infrastructure consumption levels, queue occupancy states, workload density conditions, or infrastructure saturation conditions.

Unlike conventional systems that separately evaluate network performance and infrastructure utilization, the disclosed framework continuously correlates communication-flow behavior with infrastructure operational states to determine multidimensional operational conditions associated with the hybrid network environment.

In one embodiment, the traffic condition and resource utilization condition determining module 216 may utilize predictive analysis models or machine-learning operations to forecast communication surges, workload scaling requirements, infrastructure saturation conditions, or congestion propagation events prior to occurrence of communication degradation.

For example, within a distributed e-commerce infrastructure supporting large-scale transaction processing, the traffic condition and resource utilization condition determining module 216 may predict increasing communication demand between payment-processing services and inventory-management infrastructures prior to anticipated shopping events. Responsive to such predictive analysis, the disclosed framework may proactively reserve communication bandwidth and allocate supplementary compute resources.

The traffic engineering policy generating module 218 may be configured to generate one or more traffic engineering policies based on the determined traffic conditions and the determined resource utilization conditions. The generated traffic engineering policies may define adaptive routing paths, bandwidth reservation policies, overlay tunnel configurations, communication prioritization rules, failover transition conditions, virtual switching priorities, communication scheduling rules, traffic isolation procedures, or workload orchestration operations.

In one embodiment, the traffic engineering policy generating module 218 may generate tenant-specific communication policies corresponding to individual workload priorities, service-level objectives, communication requirements, or infrastructure allocation conditions associated with respective tenants.

For example, within a hybrid banking infrastructure, latency-sensitive transaction validation services may receive high-priority communication-path allocation policies while lower-priority data archival services may utilize alternative communication paths during congestion conditions.

The network resource allocating module 220 may be configured to allocate one or more network resources according to the generated traffic engineering policies. The network resource allocating module 220 may dynamically redistribute communication flows across alternative communication paths, reserve communication bandwidth resources, allocate virtual networking resources, prioritize communication sessions, reassign compute infrastructures, or provision additional cloud resources responsive to detected network-state variations.

In one embodiment, the network resource allocating module 220 may continuously enforce modified traffic engineering policies across distributed infrastructures without interruption of active communication sessions. For example, during degradation of a cloud infrastructure region, the network resource allocating module 220 may automatically redirect communication flows toward alternative cloud regions, reserve replacement compute resources, dynamically update virtual routing configurations, and maintain uninterrupted application service continuity despite infrastructure degradation conditions.

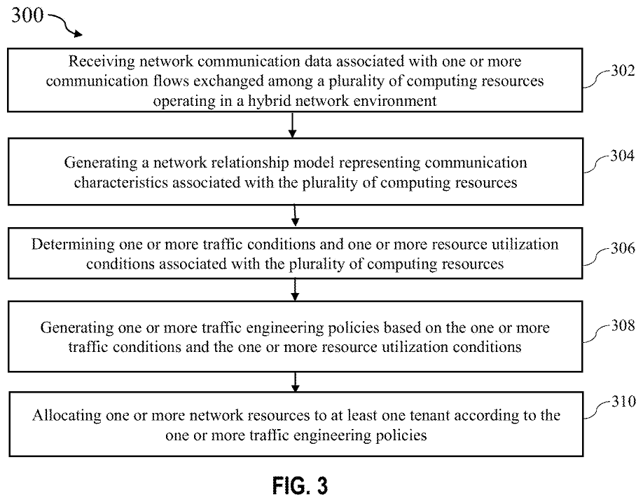

FIG. 3 illustrates a flowchart depicting a method 300 for traffic engineering and multi-tenant resource allocation in the hybrid network environment, in accordance with an embodiment of the present disclosure.

At step 302, the method 300 may include receiving, by the distributed network orchestration engine 104, the network communication data associated with the one or more communication flows exchanged among the plurality of computing resources 112a, 112b . . . 112n operating in the hybrid network environment.

At step 304, the method 300 may include generating, by the distributed network orchestration engine 104, the network relationship model 106 representing communication characteristics associated with the plurality of computing resources 112a, 112b . . . 112n. The communication characteristics may include tenant-context graph representing inter-tenant communication dependencies, workload affinity relationships, service latency requirements, bandwidth utilization parameters, and security isolation constraints associated with the plurality of tenant workloads.

At step 306, the method 300 may include determining, from the network relationship model 106, the one or more traffic conditions and the one or more resource utilization conditions associated with the plurality of computing resources 112a, 112b . . . 112n.

At step 308, the method 300 may include generating the one or more traffic engineering policies based on the one or more traffic conditions and the one or more resource utilization conditions.

At step 310, the method 300 may include allocating one or more network resources to at least one tenant according to the one or more traffic engineering policies.

The method 300 may include directing the one or more communication flows through one or more communication paths within the hybrid network environment according to the one or more traffic engineering policies.

The method 300 may include monitoring one or more operational states associated with the hybrid network environment. The method 300 may include detecting a network-state variation based on the monitored one or more operational states. The method 300 may include dynamically modifying the one or more traffic engineering policies responsive to the detected network-state variation. The method 300 may include enforcing the modified one or more traffic engineering policies to maintain communication performance and tenant-aware resource allocation within the hybrid network environment.

In an embodiment, for detecting the network-state variation, the method 300 may include detecting at least one of workload migration, tenant scaling, link degradation, one or more failover conditions, or one or more policy conflicts.

In an embodiment, for generating the network relationship model 106, the method 300 may include generating the tenant-context graph indicative of one or more communication dependencies among the plurality of computing resources 112a, 112b . . . 112n.

In an embodiment, for determining the one or more traffic conditions, the method 300 may include determining at least one of one or more latency conditions, one or more congestion conditions, one or more bandwidth utilization conditions, and one or more workload communication patterns associated with the one or more communication flows.

In an embodiment, for generating the one or more traffic engineering policies, the method 300 may include classifying the one or more communication flows into a plurality of traffic classes based on at least one of application priority, workload type, or tenant requirement, wherein the plurality of traffic classes includes a latency-sensitive traffic, a storage synchronization traffic, a compute-intensive traffic, an encrypted traffic, and an inter-domain traffic.

In an embodiment, for allocating the one or more network resources, the method 300 may include allocating one or more compute resources, one or more storage resources, one or more virtual network resources, and one or more accelerator resources among a plurality of tenants.

The method 300 may include determining the resource-allocation score associated with the at least one tenant based on at least one of the congestion probabilities, the workload mobility factor, the tenant isolation parameter, or the network path stability metric.

The one or more resource utilization conditions include one or more processor utilization levels, one or more memory consumption levels, storage access utilization, virtual network interface utilization, one or more bandwidth occupancy levels, accelerator resource consumption, one or more queue occupancy states, workload distribution density, and tenant-specific infrastructure consumption associated with the plurality of computing resources. The hybrid network environment includes at least one of an on-premise infrastructure, a cloud infrastructure, an edge infrastructure, a virtualized infrastructure, or a software-defined network infrastructure.

The methods may be implemented in any suitable hardware, software, firmware, or combination thereof.

The present disclosure provides multiple technical advantages over conventional traffic management and resource orchestration systems operating within hybrid network environments.

One technical advantage of the disclosed invention includes dynamic coordination of communication-flow management and infrastructure resource allocation across distributed hybrid network environments. Unlike conventional systems that independently manage network routing and infrastructure provisioning, the disclosed framework continuously correlates communication-flow behavior with infrastructure utilization conditions to improve overall operational efficiency and communication performance.

Another technical advantage of the disclosed invention includes generation of adaptive traffic engineering policies responsive to real-time operational conditions associated with distributed workloads. The disclosed system continuously analyzes communication dependencies, workload affinity relationships, congestion propagation characteristics, and tenant-specific operational requirements to dynamically optimize communication-path allocation throughout the hybrid network environment.

Another technical advantage of the disclosed invention includes improved congestion mitigation across distributed communication infrastructures. The disclosed framework proactively identifies congestion propagation conditions and selectively redistributes communication flows through alternative communication paths before occurrence of communication degradation, thereby reducing packet loss, communication latency, and routing instability conditions.

Another technical advantage of the disclosed invention includes intelligent tenant-aware resource orchestration within shared hybrid infrastructures. The disclosed system dynamically allocates communication bandwidth resources, compute resources, storage resources, virtual networking resources, and accelerator resources according to tenant-specific communication requirements and infrastructure utilization conditions, thereby reducing cross-tenant performance interference.

Another technical advantage of the disclosed invention includes continuous adaptation to workload migration events, infrastructure scaling operations, failover transitions, and communication-flow surges occurring within distributed computing environments. The disclosed framework automatically regenerates traffic engineering policies responsive to detected network-state variations without interruption of active communication sessions.

Another technical advantage of the disclosed invention includes generation of a dynamically evolving network relationship model representing communication dependencies, workload interaction patterns, infrastructure utilization conditions, communication-flow intensity conditions, and tenant isolation constraints associated with distributed workloads. The dynamically generated network relationship model improves operational visibility and enables intelligent communication-path optimization throughout the hybrid network environment.

Another technical advantage of the disclosed invention includes predictive determination of communication surges and infrastructure saturation conditions prior to occurrence of communication degradation. In various embodiments, predictive analysis models and machine-learning operations may forecast communication-flow bursts, workload scaling requirements, congestion propagation conditions, and infrastructure utilization trends based on historical telemetry information and real-time operational data.

Another technical advantage of the disclosed invention includes autonomous redistribution of communication flows across physical links, virtual links, software-defined overlays, cloud interconnects, and edge communication infrastructures responsive to changing operational conditions. Such adaptive communication redistribution improves communication continuity and workload availability across distributed infrastructures.

Another technical advantage of the disclosed invention includes improved utilization efficiency of distributed infrastructure resources. The disclosed framework continuously determines processor utilization levels, memory utilization conditions, storage access conditions, bandwidth occupancy levels, queue occupancy conditions, and workload distribution density conditions to optimize infrastructure allocation across multiple tenants and workloads.

Another technical advantage of the disclosed invention includes intelligent workload affinity management. The disclosed framework identifies communication relationships among highly interactive workloads and selectively positions communication paths and infrastructure resources to reduce communication latency and inter-domain traffic overhead.

Another technical advantage of the disclosed invention includes support for heterogeneous infrastructures including cloud infrastructures, edge computing environments, software-defined networking environments, virtualized infrastructures, distributed storage systems, and on-premise data centers. The disclosed framework thereby improves interoperability and operational scalability across multi-domain computing environments.

Another technical advantage of the disclosed invention includes reduction of manual administrative intervention associated with traffic engineering operations and infrastructure resource orchestration. The disclosed system autonomously generates, modifies, and enforces traffic engineering policies responsive to changing network conditions, thereby improving operational automation and infrastructure responsiveness.

Another technical advantage of the disclosed invention includes maintenance of communication continuity during infrastructure degradation conditions and failover scenarios. The disclosed framework dynamically reallocates communication paths and infrastructure resources while maintaining active communication sessions and workload availability.

Another technical advantage of the disclosed invention includes improved scalability for distributed cloud-native applications, microservice architectures, artificial intelligence infrastructures, and edge computing environments. The disclosed system continuously adapts communication-path allocation and resource distribution according to workload scaling conditions and communication-demand variations.

Another technical advantage of the disclosed invention includes improved operational intelligence through continuous telemetry aggregation and multidimensional infrastructure analysis. The disclosed framework correlates communication telemetry, workload operational conditions, infrastructure utilization states, and routing conditions to improve traffic engineering accuracy and resource allocation efficiency.

Another technical advantage of the disclosed invention includes enhanced communication prioritization for latency-sensitive workloads. The disclosed system selectively prioritizes communication flows associated with real-time transaction systems, artificial intelligence inference services, industrial automation infrastructures, emergency communication systems, and other latency-sensitive operations.

Another technical advantage of the disclosed invention includes efficient management of distributed communication flows in multi-tenant environments while maintaining tenant isolation constraints and infrastructure security conditions. The disclosed framework thereby improves service reliability and operational consistency across shared hybrid infrastructures.

Another technical advantage of the disclosed invention includes reduction of communication bottlenecks caused by static routing architectures and isolated infrastructure allocation mechanisms. The disclosed framework continuously optimizes communication routing decisions and infrastructure provisioning operations according to evolving operational conditions within the hybrid network environment.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via the system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. A method for traffic engineering and multi-tenant resource allocation in a hybrid network environment, the method comprising:
receiving, by a distributed network orchestration engine, network communication data associated with one or more communication flows exchanged among a plurality of computing resources operating in the hybrid network environment;
generating, by the distributed network orchestration engine, a network relationship model representing communication characteristics associated with the plurality of computing resources;
determining, from the network relationship model, one or more traffic conditions and one or more resource utilization conditions associated with the plurality of computing resources;
generating one or more traffic engineering policies based on the one or more traffic conditions and the one or more resource utilization conditions; and
allocating one or more network resources to at least one tenant according to the one or more traffic engineering policies.

2. The method of claim 1, further comprising:
directing the one or more communication flows through one or more communication paths within the hybrid network environment according to the one or more traffic engineering policies;
monitoring one or more operational states associated with the hybrid network environment;
detecting a network-state variation based on the monitored one or more operational states;
dynamically modifying the one or more traffic engineering policies responsive to the detected network-state variation; and
enforcing the modified one or more traffic engineering policies to maintain communication performance and tenant-aware resource allocation within the hybrid network environment.

3. The method of claim 1, wherein detecting the network-state variation comprises:
detecting at least one of workload migration, tenant scaling, link degradation, one or more failover conditions, or one or more policy conflicts.

4. The method of claim 1, wherein generating the network relationship model comprises:
generating a tenant-context graph indicative of one or more communication dependencies among the plurality of computing resources.

5. The method of claim 1, wherein determining the one or more traffic conditions comprises:
determining at least one of one or more latency conditions, one or more congestion conditions, one or more bandwidth utilization conditions, and one or more workload communication patterns associated with the one or more communication flows.

6. The method of claim 1, wherein generating the one or more traffic engineering policies comprises:
classifying the one or more communication flows into a plurality of traffic classes based on at least one of application priority, workload type, or tenant requirement, wherein the plurality of traffic classes comprises a latency-sensitive traffic, a storage synchronization traffic, a compute-intensive traffic, an encrypted traffic, and an inter-domain traffic.

7. The method of claim 1, wherein allocating the one or more network resources comprises:
allocating one or more compute resources, one or more storage resources, one or more virtual network resources, and one or more accelerator resources among a plurality of tenants.

8. The method of claim 1, further comprising:
determining a resource-allocation score associated with the at least one tenant based on at least one of a congestion probability, a workload mobility factor, a tenant isolation parameter, or a network path stability metric.

9. The method of claim 1, wherein the one or more resource utilization conditions comprise one or more processor utilization levels, one or more memory consumption levels, storage access utilization, virtual network interface utilization, one or more bandwidth occupancy levels, accelerator resource consumption, one or more queue occupancy states, workload distribution density, and tenant-specific infrastructure consumption associated with the plurality of computing resources.

10. The method of claim 1, wherein the hybrid network environment comprises at least one of an on-premise infrastructure, a cloud infrastructure, an edge infrastructure, a virtualized infrastructure, or a software-defined network infrastructure.

11. A system for traffic engineering and multi-tenant resource allocation in a hybrid network environment, the system comprising:
a memory;
at least one processor is operatively coupled with the memory, wherein the at least one processor is configured to:
receive, using a distributed network orchestration engine, network communication data associated with one or more communication flows exchanged among a plurality of computing resources operating in the hybrid network environment;
generate, using the distributed network orchestration engine, a network relationship model representing communication characteristics associated with the plurality of computing resources;
determine, from the network relationship model, one or more traffic conditions and one or more resource utilization conditions associated with the plurality of computing resources;
generate one or more traffic engineering policies based on the one or more traffic conditions and the one or more resource utilization conditions; and
allocate one or more network resources to at least one tenant according to the one or more traffic engineering policies.

12. The system of claim 11, wherein the at least one processor is configured to:
direct the one or more communication flows through one or more communication paths within the hybrid network environment according to the one or more traffic engineering policies, wherein the hybrid network environment comprises at least one of an on-premise infrastructure, a cloud infrastructure, an edge infrastructure, a virtualized infrastructure, or a software-defined network infrastructure;
monitor one or more operational states associated with the hybrid network environment;
detect a network-state variation based on the monitored one or more operational states;
dynamically modify the one or more traffic engineering policies responsive to the detected network-state variation; and
enforce the modified one or more traffic engineering policies to maintain communication performance and tenant-aware resource allocation within the hybrid network environment.

13. The system of claim 11, wherein to detect the network-state variation, the at least one processor is configured to:
detect at least one of workload migration, tenant scaling, link degradation, one or more failover conditions, or one or more policy conflicts.

14. The system of claim 11, wherein to generate the network relationship model, the at least one processor is configured to:
generate a tenant-context graph indicative of one or more communication dependencies among the plurality of computing resources.

15. The system of claim 11, wherein to determine the one or more traffic conditions, the at least one processor is configured to:
determine at least one of one or more latency conditions, one or more congestion conditions, one or more bandwidth utilization conditions, and one or more workload communication patterns associated with the one or more communication flows.

16. The system of claim 11, wherein to generate the one or more traffic engineering policies, the at least one processor is configured to:
classify the one or more communication flows into a plurality of traffic classes based on at least one of application priority, workload type, or tenant requirement, wherein the plurality of traffic classes comprises a latency-sensitive traffic, a storage synchronization traffic, a compute-intensive traffic, an encrypted traffic, and an inter-domain traffic.

17. The system of claim 11, wherein to allocate the one or more network resources, the at least one processor is configured to:
allocate one or more compute resources, one or more storage resources, one or more virtual network resources, and one or more accelerator resources among a plurality of tenants.

18. The system of claim 11, wherein the at least one processor is configured to:
determine a resource-allocation score associated with the at least one tenant based on at least one of a congestion probability, a workload mobility factor, a tenant isolation parameter, or a network path stability metric.

19. The system of claim 11, wherein the one or more resource utilization conditions comprise one or more processor utilization levels, one or more memory consumption levels, storage access utilization, virtual network interface utilization, one or more bandwidth occupancy levels, accelerator resource consumption, one or more queue occupancy states, workload distribution density, and tenant-specific infrastructure consumption associated with the plurality of computing resources.

20. A non-transitory computer-readable medium storing instructions that, when executed, cause a processor to:
receive network communication data associated with one or more communication flows exchanged among a plurality of computing resources operating in the hybrid network environment;
generate a network relationship model representing communication characteristics associated with the plurality of computing resources;
determine one or more traffic conditions and one or more resource utilization conditions associated with the plurality of computing resources;
generate one or more traffic engineering policies based on the one or more traffic conditions and the one or more resource utilization conditions; and
allocate one or more network resources to at least one tenant according to the one or more traffic engineering policies.
